(19) United States
(12) Patent Application Publication
(10) Pub. No.: US 2016/0100166 A1
(43) Pub. Date: Apr. 7, 2016

(54) Adapting Quantization

(71) Applicant: Microsoft Technology Licensing, LLC, Redmond, WA (US)

(72) Inventors: Lucian Dragne, London (GB); Hans Peter Hess, London (GB)

(21) Appl. No.: 14/560,669

(22) Filed: Dec. 4, 2014

(30) Foreign Application Priority Data
Oct. 3, 2014 (GB) 1417536.8

(51) Int. Cl. H04N 19/124; H04N 19/51; H04N 5/44; G06K 9/00; G06K 9/46

(52) U.S. Cl. CPC H04N 19/124; G06K 9/00362; G06K 9/46; G06K 9/00375; H04N 5/44; H04N 19/51; G06K 2009/4666

(57) ABSTRACT

A device comprising: an encoder for encoding a video signal representing a video image of a scene captured by a camera, and a controller. The encoder comprises a quantizer for performing a quantization on the video signal as part of said encoding. The controller is configured to receive skeletal tracking information from a skeletal tracking algorithm relating to one or more skeletal features of a user present in the scene, and based thereon to define one or more regions-of-interest within the video image corresponding to one or more bodily areas of the user, and to adapt the quantization to use a finer quantization granularity within the one or more regions-of-interest than outside the one or more regions-of interest.

### RELATED APPLICATIONS

This application claims priority under 35 USC §119 or §365 to Great Britain Patent Application No. 1417536.8, filed Oct. 3, 2014, the disclosure of which is incorporate in its entirety.

### BACKGROUND

In video coding, quantization is the process of converting samples of the video signal (typically the transformed residual samples) from a representation on a finer granularity scale to a representation on a coarser granularity scale. In many cases, quantization may be thought of as converting from values on an effectively continuously-variable scale to values on a substantially discrete scale. For example, if the transformed residual YUV or RGB samples in the input signal are each represented by values on a scale from 0 to 255 (8 bits), the quantizer may convert these to being represented by values on a scale from 0 to 15 (4 bits). The minimum and maximum possible values 0 and 15 on the quantized scale still represent the same (or approximately the same) minimum and maximum sample amplitudes as the minimum and maximum possible values on the unquantized input scale, but now there are fewer levels of gradation in between. That is, the step size is reduced. Hence some detail is lost from each frame of the video, but the signal is smaller in that it incurs fewer bits per frame. Quantization is sometimes expressed in terms of a quantization parameter (QP), with a lower QP representing a finer granularity and a higher QP representing a coarser granularity.

Note: quantization specifically refers to the process of converting the value representing each given sample from a representation on a finer granularity scale to a representation on a coarser granularity scale. Typically this means quantizing one or more of the colour channels of each coefficient of the residual signal in the transform domain, e.g. each RGB (red, green blue) coefficient or more usually YUV (luminance and two chrominance channels respectively). For instance a Y value input on a scale from 0 to 255 may be quantized to a scale from 0 to 15, and similarly for U and V, or RGB in an alternative colour space (though generally the quantization applied to each colour channel does not have to be the same). The number of samples per unit area is referred to as resolution, and is a separate concept. The term quantization is not used to refer to a change in resolution, but rather a change in granularity per sample.

Video encoding is used in a number of applications where the size of the encoded signal is a consideration, for instance when transmitting a real-time video stream such as a stream of a live video call over a packet-based network such as the Internet. Using a finer granularity quantization results in less distortion in each frame (less information is thrown away) but incurs a higher bitrate in the encoded signal. Conversely, using a coarser granularity quantization incurs a lower bitrate but introduces more distortion per frame.

Some codecs allow for one or more sub-areas to be defined within the frame area, in which the quantization parameter can be set to a lower value (finer quantization granularity) than the remaining areas of the frame. Such a sub-area is often referred the “region-of-interest” (ROI), while the remaining areas outside the ROI(s) are often referred to as the “background”. The technique allows more bits to be spent on areas of each frame which are more perceptually significant and/or where more activity is expected to occur, whilst wasting fewer bits on the parts of the frame that are of less significance, thus providing a more intelligent balance between the bitrate saved by coarser quantization and the quality gained by finer quantization. For example, in a video call the video usually takes the form of a “talking head” shot, comprising the user's head, face and shoulder's against a static background. Hence in the case of encoding video to be transmitted as part of a video call such as a VoIP call, the ROI may correspond to an area around the user's head or head and shoulders.

In some cases the ROI is just defined as a fixed shape, size and position within the frame area, e.g. on the assumption that the main activity (e.g. the face in a video call) tends to occur roughly within a central rectangle of the frame. In other cases, a user can manually select the ROI. More recently, techniques have been proposed that will automatically define the ROI as the region around a person's face appearing in the video, based on a face recognition algorithm applied to the target video.

### SUMMARY

However, the scope of the existing techniques is limited. It would be desirable to find an alternative technique for automatically defining one or more regions-of-interest in which to apply a finer quantization, which can taking into account other types of activity that may be perceptually relevant other than just than just a “talking head”, thereby striking a more appropriate balance between quality and bitrate across a wider range of scenarios.

Recently skeletal tracking systems have become available, which use a skeletal tracking algorithm and one or more skeletal tracking sensors such as an infrared depth sensor to track one or more skeletal features of a user. Typically these are used for gesture control, e.g. to control a computer game. However, it is recognised herein that such a system could have an application to automatically defining one or more regions-of-interest within a video for quantization purposes.

According to one aspect disclosed herein, there is provided a device comprising an encoder for encoding a video signal representing a video image of a scene captured by a camera, and a controller for controlling the encoder. The encoder comprises a quantizer for performing a quantization on said video signal as part of said encoding. The controller is configured to receive skeletal tracking information from a skeletal tracking algorithm, relating to one or more skeletal features of a user present in said scene. Based thereon, the controller defines one or more regions-of-interest within the video image corresponding to one or more bodily areas of the user, and adapts the quantization to use a finer quantization granularity within the one or more regions-of-interest than outside the one or more regions-of interest.

The regions-of-interest may be spatially exclusive of one another or may overlap. For instance, each of the bodily areas defined as part of the scheme in question may be one of: (a) the user's whole body; (b) the user's head, torso and arms; (c) the user's head, thorax and arms; (d) the user's head and shoulders; (e) the user's head; (f) the user's torso (g) the user's thorax; (h) the user's abdomen; (i) the user's arms and hands; (j) the user's shoulders; or (k) the user's hands.

In the case of a plurality of different regions-of-interest, a finer granularity quantization may be applied in some or all of the regions-of-interest at the same time, and/or may be applied in some or all of the regions-of-interest only at certain times (including the possibility of quantizing different ones of the regions-of-interest with the finer granularity at different times). Which of the regions-of-interest are currently selected for finer quantization may be adapted dynamically based on a bitrate constraint, e.g. limited by the current bandwidth of a channel over which the encoded video is to be transmitted. In embodiments, the bodily areas are assigned an order of priority, and the selection is performed according to the order of priority of the body parts to which the different regions-of-interest correspond. For example, when the available bandwidth is high, then the ROI corresponding to (a) the user's whole body may be quantized at the finer granularity; while when the available bandwidth is lower, then the controller may select to apply the finer granularity only in the ROI corresponding to, say, (b) the user's head, torso and arms, or (c) the user's head, thorax and arms, or (d) the user's head and shoulders, or even only (e) the user's head.

In alternative or additional embodiments, the controller may be configured to adapt the quantization to use different levels of quantization granularity within different ones of the regions-of interest, each being finer than outside the regions-of-interest. The different levels may be set according to the order of priority of the body parts to which the different regions-of-interest correspond. For example, the head may be encoded with a first, highest quantization granularity; while the hands, arms, shoulders, thorax and/or torso may be encoded with one or more second, somewhat coarser levels of quantization granularity; and the rest of the body may be encoded with a third level of quantization granularity that is coarser than the second but still finer than outside the ROIs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference will be made by way of example to the accompanying drawings in which:

FIG. 1 is a schematic block diagram of a communication system,

FIG. 2 is a schematic block diagram of an encoder,

FIG. 3 is a schematic block diagram of a decoder,

FIG. 4 is a schematic illustration of different quantization parameter values,

FIG. 5a schematically represents defining a plurality of ROIs in a captured video image,

FIG. 5b is another schematic representation of ROIs in a captured video image,

FIG. 5c is another schematic representation of ROIs in a captured video image,

FIG. 5d is another schematic representation of ROIs in a captured video image,

FIG. 6 is a schematic block diagram of a user device,

FIG. 7 is a schematic illustration of a user interacting with a user device,

FIG. 8a is a schematic illustration of a radiation pattern,

FIG. 8b is a schematic front view of a user being irradiated by a radiation pattern, and

FIG. 9 is a schematic illustration of detected skeletal points of a user.

### DETAILED DESCRIPTION OF EMBODIMENTS

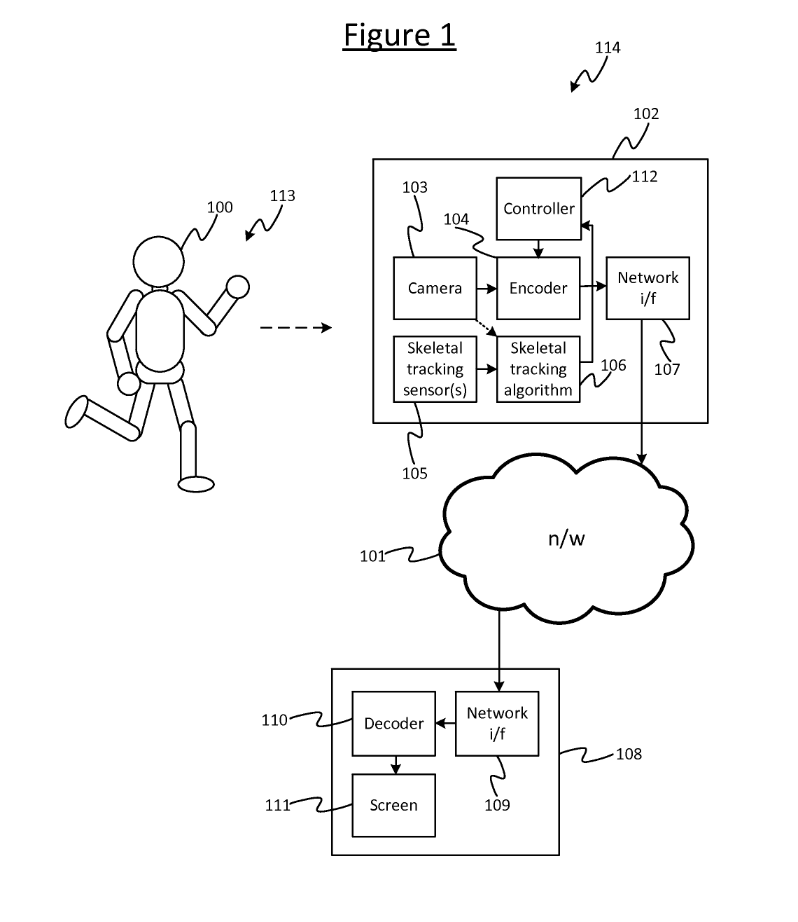

FIG. 1 illustrates a communication system 114 comprising a network 101, a first device in the form of a first user terminal 102, and a second device in the form of a second user terminal 108. In embodiments, the first and second user terminals 102, 108 may each take the form of a smartphone, a tablet, a laptop or desktop computer, or a games console or set-top box connected to a television screen. The network 101 may for example comprise a wide-area internetwork such as the Internet, and/or a wide-area intranet within an organization such as a company or university, and/or any other type of network such as a mobile cellular network. The network 101 may comprise a packet-based network, such as an internet protocol (IP) network.

The first user terminal 102 is arranged to capture a live video image of a scene 113, to encode the video in real-time, and to transmit the encoded video in real-time to the second user terminal 108 via a connection established over the network 101. The scene 113 comprises, at least at times, a (human) user 100 present in the scene 113 (meaning in embodiments that at least part of the user 100 appears in the scene 113). For instance, the scene 113 may comprise a “talking head” (face-on head and shoulders) to be encoded and transmitted to the second user terminal 108 as part of a live video call, or video conference in the case of multiple destination user terminals. By “real-time” here it is meant that the encoding and transmission happen while the events being captured are still ongoing, such that an earlier part of the video is being transmitted while a later part is still being encoded, and while a yet-later part to be encoded and transmitted is still ongoing in the scene 113, in a continuous stream. Note therefore that “real-time” does not preclude a small delay.

The first (transmitting) user terminal 102 comprises a camera 103, an encoder 104 operatively coupled to the camera 103, and a network interface 107 for connecting to the network 101, the network interface 107 comprising at least a transmitter operatively coupled to the encoder 104. The encoder 104 is arranged to receive an input video signal from the camera 103, comprising samples representing the video image of the scene 113 as captured by the camera 103. The encoder 104 is configured to encode this signal in order to compress it for transmission, as will be discussed in more detail shortly. The transmitter 107 is arranged to receive the encoded video from the encoder 104, and to transmit it to the second terminal 102 via a channel established over the network 101. In embodiments this transmission comprises a real-time streaming of the encoded video, e.g. as the outgoing part of a live video call.

According to embodiments of the present disclosure, the user terminal 102 also comprises a controller 112 operatively coupled to the encoder 104, and configured to thereby set one or more regions-of-interest (ROIs) within the area of the captured video image and to control the quantization parameter (QP) both inside and outside the ROI(s). Particularly, the controller 112 is able to control the encoder 104 to use a different QP inside the one or more ROIs than in the background.

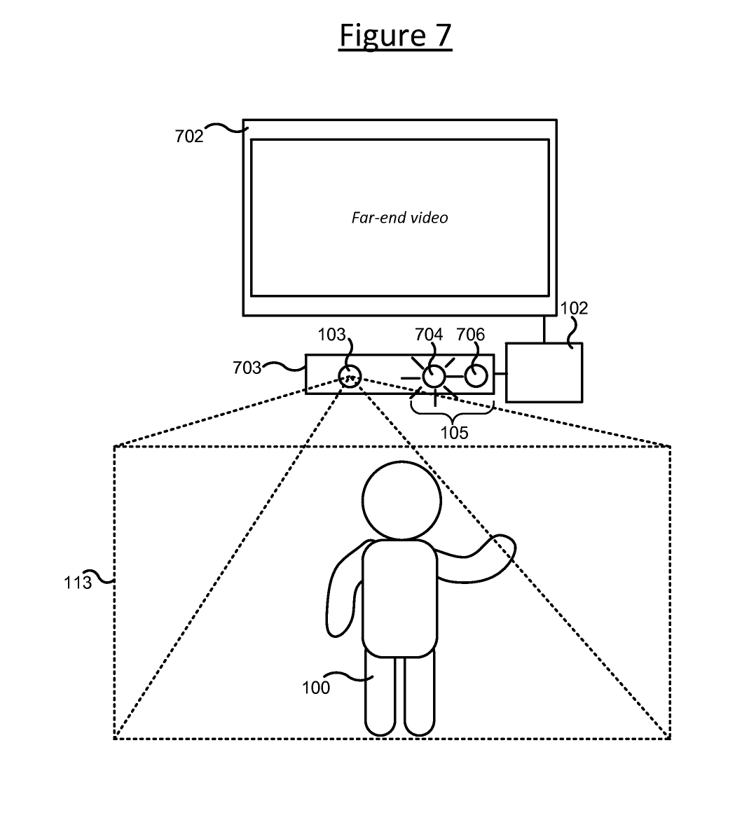

Further, the user terminal 102 comprises one or more dedicated skeletal tracking sensors 105, and a skeletal tracking algorithm 106 operatively coupled to the skeletal tracking sensor(s) 105. For example the one or more skeletal tracking sensors 105 may comprise a depth sensor such as an infrared (IR) depth sensor as discussed later in relation to FIGS. 7-9, and/or another form of dedicated skeletal tracking camera (a separate camera from the camera 103 used to capture the video being encoded), e.g. which may work based on capturing visible light or non-visible light such as IR, and which may be a 2D camera or a 3D camera such as a stereo camera or a fully depth-aware (ranging) camera.

Each of the encoder 104, controller 112 and skeletal tracking algorithm 106 may be implemented in the form of software code embodied on one or more storage media of the user terminal 102 (e.g. a magnetic medium such as a hard disk or an electronic medium such as an EEPROM or “flash” memory) and arranged for execution on one or more processors of the user terminal 102. Alternatively it is not excluded that one or more of these components 104, 112, 106 may be implemented in dedicated hardware, or a combination of software and dedicated hardware. Note also that while they have been described as being part of the user terminal 102, in embodiments the camera 103, skeletal tracking sensor(s) 105 and/or skeletal tracking algorithm 106 could be implemented in one or more separate peripheral devices in communication with the user terminal 103 via a wired or wireless connection.

The skeletal tracking algorithm 106 is configured to use the sensory input received from the skeletal tracking sensors(s) 105 to generate skeletal tracking information tracking one or more skeletal features of the user 100. For example, the skeletal tracking information may track the location of one or more joints of the user 100, such as one or more of the user's shoulders, elbows, wrists, neck, hip joints, knees and/or ankles; and/or may track a line or vector formed by one or more bones of the human body, such as the vectors formed by one or more of the user's forearms, upper arms, neck, thighs, lower legs, head-to-neck, neck-to-waist (thorax) and/or waist-to-pelvis (abdomen). In some potential embodiments, the skeletal tracking algorithm 106 may optionally be configured to augment the determination of the this skeletal tracking information based on image recognition applied to the same video image that is being encoded, from the same camera 103 as used to capture the image being encoded. Alternatively the skeletal tracking is based only on the input from the skeletal tracking sensor(s) 105. Either way, the skeletal tracking is at least in part based on the separate skeletal tracking sensor(s) 105.

Skeletal tracking algorithms are in themselves available in the art. For instance, the Xbox One software development kit (SDK) includes a skeletal tracking algorithm which an application developer can access to receiving skeletal tracking information, based on the sensory input from the Kinect peripheral. In embodiments the user terminal 102 is an Xbox One games console, the skeletal tracking sensors 105 are those implemented in the Kinect sensor peripheral, and the skeletal tracking algorithm is that of the Xbox One SDK. However this is only an example, and other skeletal tracking algorithms and/or sensors are possible.

The controller 112 is configured to receive the skeletal tracking information from the skeletal tracking algorithm 106 and thereby identify one or more corresponding bodily areas of the user within the captured video image, being areas which are of more perceptual significance than others and therefore which warrant more bits being spent in the encoding. Accordingly, the controller 112 defines one or more corresponding regions-of-interest (ROIs) within the captured video image which cover (or approximately cover) these bodily areas. The controller 112 then adapts the quantization parameter (QP) of the encoding being performed by the encoder 104 such that a finer quantization is applied inside the ROI(s) than outside. This will be discussed in more detail shortly.

In embodiments, the skeletal tracking sensor(s) 105 and algorithm 106 are already provided as a “natural user interface” (NUI) for the purpose of receiving explicit gesture-based user inputs by which the user consciously and deliberately chooses to control the user terminal 102, e.g. for controlling a computer game. However, according to embodiments of the present disclosure, the NUI is exploited for another purpose, to implicitly adapt the quantization when encoding a video. The user just acts naturally as he or she would anyway during the events occurring in the scene 113, e.g. talking and gesticulating normally during the video call, and does not need to be aware that his or her actions are affecting the quantization.

At the receive side, the second (receiving) user terminal 108 comprises a screen 111, a decoder 110 operatively coupled to the screen 111, and a network interface 109 for connecting to the network 101, the network interface 109 comprising at least a receiver being operatively coupled to the decoder 110. The encoded video signal is transmitted over the network 101 via a channel established between the transmitter 107 of the first user terminal 102 and the receiver 109 of the second user terminal 108. The receiver 109 receives the encoded signal and supplies it to the decoder 110. The decoder 110 decodes the encoded video signal, and supplies the decoded video signal to the screen 111 to be played out. In embodiments, the video is received and played out as a real-time stream, e.g. as the incoming part of a live video call.

Note: for illustrative purposes, the first terminal 102 is described as the transmitting terminal comprising transmit-side components 103, 104, 105, 106, 107, 112 and the second terminal 108 is described as the receiving terminal comprising receive-side components 109, 110, 111; but in embodiments, the second terminal 108 may also comprise transmit-side components (with or without the skeletal tracking) and may also encode and transmit video to the first terminal 102, and the first terminal 102 may also comprise receive-side components for decoding, receiving and playing out video from the second terminal 109. Note also that, for illustrative purposes, the disclosure herein has been described in terms of transmitting video to a given receiving terminal 108; but in embodiments the first terminal 102 may in fact transmit the encoded video to one or a plurality of second, receiving user terminals 108, e.g. as part of a video conference.

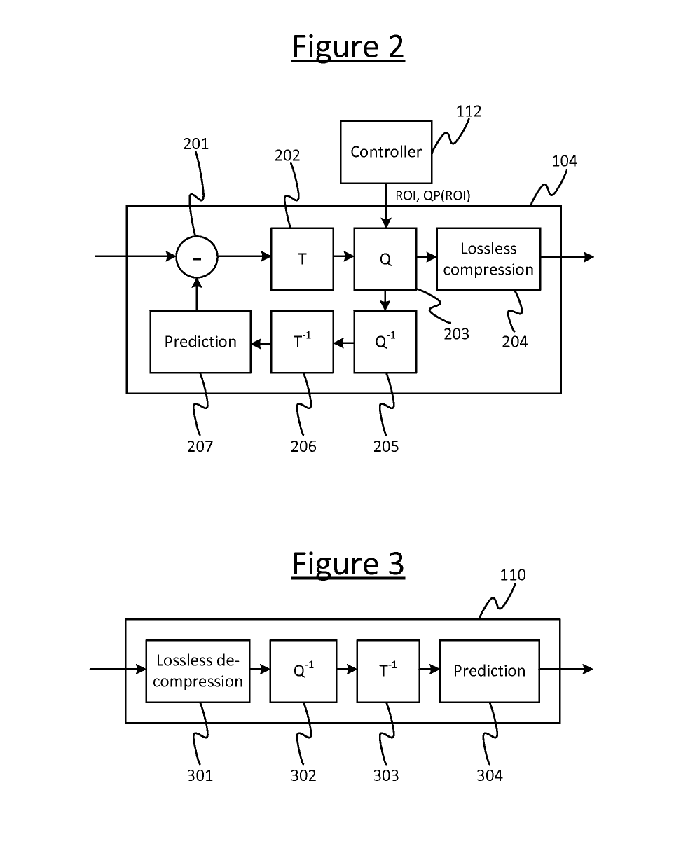

FIG. 2 illustrates an example implementation of the encoder 104. The encoder 104 comprises: a subtraction stage 201 having a first input arranged to receive the samples of the raw (unencoded) video signal from the camera 103, a prediction coding module 207 having an output coupled to a second input of the subtraction stage 201, a transform stage 202 (e.g. DCT transform) having an input operatively coupled to an output of the subtraction stage 201, a quantizer 203 having an input operatively coupled to an output of the transform stage 202, a lossless compression module 204 (e.g. entropy encoder) having an input coupled to an output of the quantizer 203, an inverse quantizer 205 having an input also operatively coupled to the output of the quantizer 203, and an inverse transform stage 206 (e.g. inverse DCT) having an input operatively coupled to an output of the inverse quantizer 205 and an output operatively coupled to an input of the prediction coding module 207.

In operation, each frame of the input signal from the camera 103 is divided into a plurality of blocks (or macroblocks or the like—“block” will be used as a generic term herein which could refer to the blocks or macroblocks of any given standard). The input of the subtraction stage 201 receives a block to be encoded from the input signal (the target block), and performs a subtraction between this and a transformed, quantized, reverse-quantized and reverse-transformed version of another block-size portion (the reference portion) either in the same frame (intra frame encoding) or a different frame (inter frame encoding) as received via the input from the prediction coding module 207 —representing how this reference portion would appear when decoded at the decode side. The reference portion is typically another, often adjacent block in the case of intra-frame encoding, while in the case of inter-frame encoding (motion prediction) the reference portion is not necessarily constrained to being offset by an integer number of blocks, and in general the motion vector (the spatial offset between the reference portion and the target block, e.g. in x and y coordinates) can be any number of pixels or even fractional integer number of pixels in each direction.

The subtraction of the reference portion from the target block produces the residual signal—i.e. the difference between the target block and the reference portion of the same frame or a different frame from which the target block is to be predicted at the decoder 110. The idea is that the target block is encoded not in absolute terms, but in terms of a difference between the target block and the pixels of another portion of the same or a different frame. The difference tends to be smaller than the absolute representation of the target block, and hence takes fewer bits to encode in the encoded signal.

The residual samples of each target block are output from the output of the subtraction stage 201 to the input of the transform stage 202 to be transformed to produce corresponding transformed residual samples. The role of the transform is to transform from a spatial domain representation, typically in terms of Cartesian x and y coordinates, to a transform domain representation, typically a spatial-frequency domain representation (sometimes just called the frequency domain). That is, in the spatial domain, each colour channel (e.g. each of RGB or each of YUV) is represented as a function of spatial coordinates such as x and y coordinates, with each sample representing the amplitude of a respective pixel at different coordinates; whereas in the frequency domain, each colour channel is represented as a function of spatial frequency having dimensions 1/distance, with each sample representing a coefficient of a respective spatial frequency term. For example the transform may be a discrete cosine transform (DCT).

The transformed residual samples are output from the output of the transform stage 202 to the input of the quantizer 203 to be quantized into quantized, transformed residual samples. As discussed previously, quantization is the process of converting from a representation on a higher granularity scale to a representation on a lower granularity scale, i.e. mapping a large set of input values to a smaller set. Quantization is a lossy form of compression, i.e. detail is being “thrown away”. However, it also reduces the number of bits needed to represent each sample.

The quantized, transformed residual samples are output from the output of the quantizer 203 to the input of the lossless compression stage 204 which is arranged to perform a further, lossless encoding on the signal, such as entropy encoding. Entropy encoding works by encoding more commonly-occurring sample values with codewords consisting of a smaller number of bits, and more rarely-occurring sample values with codewords consisting of a larger number of bits. In doing so, it is possible to encode the data with a smaller number of bits on average than if a set of fixed length codewords was used for all possible sample values. The purpose of the transform 202 is that in the transform domain (e.g. frequency domain), more samples typically tend to quantize to zero or small values than in the spatial domain. When there are more zeros or a lot of the same small numbers occurring in the quantized samples, then these can be efficiently encoded by the lossless compression stage 204.

The lossless compression stage 204 is arranged to output the encoded samples to the transmitter 107, for transmission over the network 101 to the decoder 110 on the second (receiving) terminal 108 (via the receiver 110 of the second terminal 108).

The output of the quantizer 203 is also fed back to the inverse quantizer 205 which reverse quantizes the quantized samples, and the output of the inverse quantizer 205 is supplied to the input of the inverse transform stage 206 which performs an inverse of the transform 202 (e.g. inverse DCT) to produce an inverse-quantized, inverse-transformed versions of each block. As quantization is a lossy process, each of the inverse-quantized, inverse-transformed blocks will contain some distortion relative to the corresponding original block in the input signal. This represents what the decoder 110 will see. The prediction coding module 207 can then use this to generate a residual for further target blocks in the input video signal (i.e. the prediction coding encodes in terms of the residual between the next target block and how the decoder 110 will see the corresponding reference portion from which it is predicted).

FIG. 3 illustrates an example implementation of the decoder 110. The decoder 110 comprises: a lossless decompression stage 301 having an input arranged to receive the samples of the encoded video signal from the receiver 109, an inverse quantizer 302 having an input operatively coupled to an output of the lossless decompression stage 301, an inverse transform stage 303 (e.g. inverse DCT) having an input operatively coupled to an output of the inverse quantizer 302, and a prediction module 304 having an input operatively coupled to an output of the inverse transform stage 303.

In operation, the inverse quantizer 302 reverse quantizes the received (encoded residual) samples, and supplies these de-quantized samples to the input of the inverse transform stage 303. The inverse transform stage 303 performs an inverse of the transform 202 (e.g. inverse DCT) on the de-quantized samples, to produce an inverse-quantized, inverse-transformed versions of each block, i.e. to transform each block back to the spatial domain. Note that at this stage, theses blocks are still blocks of the residual signal. These residual, spatial-domain blocks are supplied from the output of the inverse transform stage 303 to the input of the prediction module 304. The prediction module 304 uses the inverse-quantized, inverse-transformed residual blocks to predict, in the spatial domain, each target block from its residual plus the already-decoded version of its corresponding reference portion from the same frame (intra frame prediction) or from a different frame (inter frame prediction). In the case of inter-frame encoding (motion prediction), the offset between the target block and the reference portion is specified by the respective motion vector, which is also included in the encoded signal. In the case of intra-frame encoding, which block to use as the reference block is typically determined according to a predetermined pattern, but alternatively could also be signalled in the encoded signal.

The operation of the quantizer 203 under control of the controller 112 at the encode-side is now discussed in more detail.

The quantizer 203 is operable to receive an indication of one or more regions-of-interest (ROIs) from the controller 112, and (at least sometimes) apply a different quantization parameter (QP) value in the ROIs than outside. In embodiments, the quantizer 203 is operable to apply different QP values in different ones of multiple ROIs. An indication of the ROI(s) and corresponding QP values are also signalled to the decoder 110 so the corresponding inverse quantization can be performed by the inverse quantizer 302.

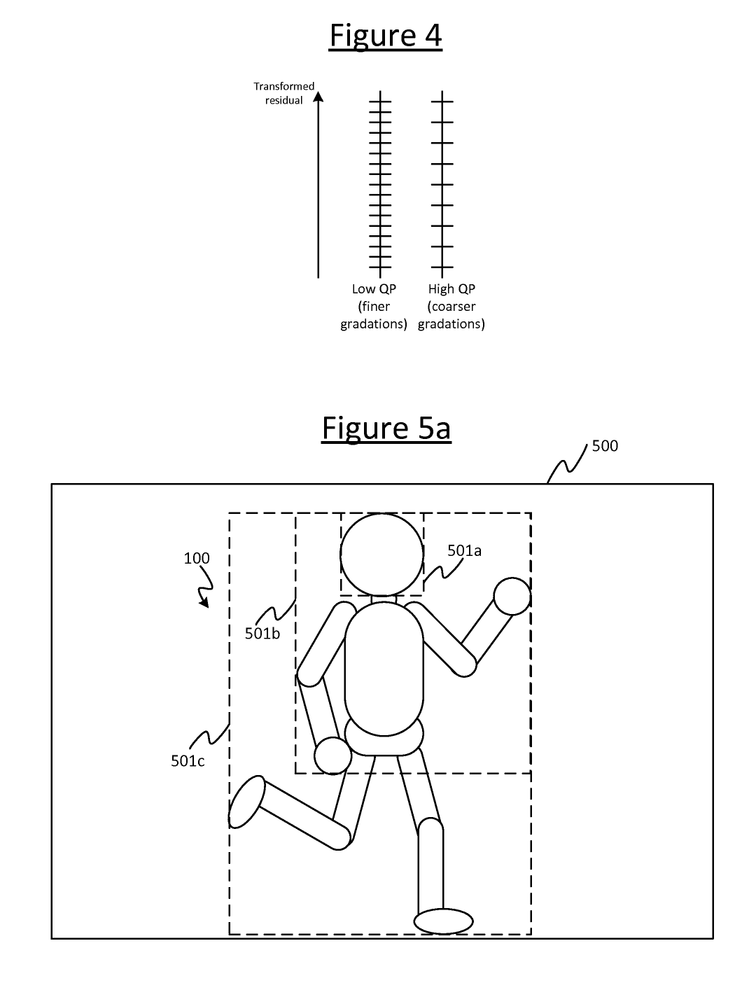

FIG. 4 illustrates the concept of quantization. The quantization parameter (QP) is an indication of the step size used in the quantization. A low QP means the quantized samples are represented on a scale with finer gradations, i.e. more closely-spaced steps in the possible values the samples can take (so less quantization compared to the input signal); while a high QP means the samples are represented on a scale with coarser gradations, i.e. more widely-spaced steps in the possible values the samples can take (so more quantization compared to the input signal). Low QP signals incur more bits than low QP signals, because a larger number of bits is needed to represent each value. Note, the step size is usually regular (evenly spaced) over the whole scale, but it doesn't necessarily have to be so in all possible embodiments. In the case of a non-uniform change in step size, an increase/decrease could for example mean an increase/decrease in an average (e.g. mean) of the step size, or an increase/decrease in the step size only in a certain region of the scale.

Depending on the encoder, the ROI(s) may be specified in a number of ways. In some encoders each of the one or more ROIs may be limited to being defined as a rectangle (e.g. only in terms of horizontal and vertical bounds), or in other encoders it is possible to define on a block-by-block basis (or macro-block-by-macroblock or the like) which individual block (or macroblock) forms part of the ROI. In some embodiments, the quantizer 203 supports a respective QP value being specified for each individual block (or macroblock). In this case the QP value for each block (or macroblock or the like) is signalled to the decoder as part of the encoded signal.

As mentioned previously, the controller 112 at the encode side is configured to receive skeletal tracking information from the skeletal tracking algorithm 106, and based on this to dynamically define the ROI(s) so as to correspond to one or more respective bodily features that are most perceptually significant for encoding purposes, and to set the QP value(s) for the ROI(s) accordingly. In embodiments the controller 112 may only adapt the size, shape and/or placement or the ROI(s), with a fixed value of QP being used inside the ROI(s) and another (higher) fixed value being used outside. In this case the quantization is being adapted only in terms of where the lower QP (finer quantization) is being applied and where it is not. Alternatively the controller 112 may be configured to adapt both the ROI(s) and the QP value(s), i.e. so the QP applied inside the ROI(s) is also a variable that is dynamically adapted (and potentially so is the QP outside).

By dynamically adapt is meant “on the fly”, i.e. in response to ongoing conditions; so as the user 100 moves within the scene 113 or in and out of the scene 113, the current encoding state adapts accordingly. Thus the encoding of the video adapts according to what the user 100 being recorded is doing and/or where he or she is at the time of the video being captured.

Thus there is described herein a technique which uses information from the NUI sensor(s) 105 to perform skeleton tracking and compute region(s)-of-interest (ROI), then adapts the QP in the encoder such that region(s)-of-interest are encoded at better quality than the rest of the frame. This can save bandwidth if the ROI is a small proportion of the frame.

In embodiments the controller 112 is a bitrate controller of the encoder 104 (note that the illustration of encoder 104 and controller 112 is only schematic and the controller 112 could equally be considered a part of the encoder 104). The bitrate controller 112 is responsible for controlling one or more properties of the encoding which will affect the bitrate of the encoded video signal, in order to meet a certain bitrate constraint. Quantization is one such property: lower QP (finer quantization) incurs more bits per unit time of video, while higher QP (coarser quantization) incurs fewer bits per unit time of video.

For example, the bitrate controller 112 may be configured to dynamically determine a measure the available bandwidth over the channel between the transmitting terminal 102 and receiving terminal 108, and the bitrate constraint is a maximum bitrate budget limited by this—either being set equal to the maximum available bandwidth or determined as some function of it. Alternatively rather than a simple maximum, the bitrate constraint may be a result of more complex rate-distortion optimization (RDO) process. Details of various RDO processes will be familiar to a person skilled in the art. Either way, in embodiments the controller 112 is configured to take into account such constraints on the bitrate when adapting the ROI(s) and/or the respective QP value(s).

For instance, the controller 112 may select a smaller ROI or a limit the number of body parts allocated an ROI when bandwidth conditions are poor, and/or if an RDO algorithm indicates that the current bitrate being spent on quantizing the ROI(s) is having little benefit; but otherwise if the bandwidth conditions are good and/or the RDO algorithm indicates it would be beneficial, the controller 112 may select a larger ROI or allocate ROIs to more body parts. Alternatively or additionally, the controller 112 may select a smaller QP value for the ROI(s) if bandwidth conditions are poor and/or the RDO algorithm indicates it would not currently be beneficial to spend more on quantization; but otherwise if the bandwidth conditions are good and/or the RDO algorithm indicates it would be beneficial, the controller 112 may select a larger QP value for the ROI(s).

E.g. in VoIP-calling video communications there often has to be a trade-off between the quality of the image and the network bandwidth that is used. Embodiments of the present disclosure try to maximize the perceived quality of the video being sent, while keeping bandwidth at feasible levels.

Furthermore, in embodiments the use of skeletal tracking can be more efficient compared to other potential approaches. Trying to analyse what the user is doing in a scene can be very computationally expensive. However, some devices have reserved processing resources set aside for certain graphics functions such as skeletal tracking, e.g. dedicated hardware or reserved processor cycles. If these are used for the analysis of the user's motion based on skeletal tracking, then this can relieve the processing burden on the general-purpose processing resources being used to run the encoder, e.g. as part of the VoIP client or other such communication client application conducting the video call.

For instance, as illustrated in FIG. 6, the transmitting user terminal 102 may comprise a dedicated graphics processor (GPU) 602 and general purpose processor (e.g. a CPU) 601, with the graphics processor 602 being reserved for certain graphics processing operations including skeletal tracking. In embodiments, the skeletal tracking algorithm 106 may be arranged to run on the graphics processor 602, while the encoder 104 may be arranged to run on the general purpose processor 601 (e.g. as part of a VoIP client or other such video calling client running on the general purpose processor). Further, in embodiments, the user terminal 102 may comprise a “system space” and a separate “application space”, where these spaces are mapped onto separate GPU and CPU cores and different memory resources. In such cases, the skeleton tracking algorithm 106 may be arranged to run in the system space, while the communication application (e.g. VoIP client) comprising the encoder 104 runs in the application space. An example of such a user terminal is the Xbox One, though other possible devices may also use a similar arrangement.

Some example realizations of the skeletal tracking and the selection of corresponding ROIs are now discussed in more detail.

FIG. 7 shows an example arrangement in which the skeletal tracking sensor 105 is used to detect skeletal tracking information. In this example, the skeletal tracking sensor 105 and the camera 103 which captures the outgoing video being encoded are both incorporated in the same external peripheral device 703 connected to the user terminal 102, with the user terminal 102 comprising the encoder 104, e.g. as part of a VoIP client application. For instance the user terminal 102 may take the form of a games console connected to a television set 702, through which the user 100 views the incoming video of the VoIP call. However, it will be appreciated that this example is not limiting.

In embodiments, the skeletal tracking sensor 105 is an active sensor which comprises a projector 704 for emitting non-visible (e.g. IR) radiation and a corresponding sensing element 706 for sensing the same type of non-visible radiation reflected back. The projector 704 is arranged to project the non-visible radiation forward of the sensing element 706, such that the non-visible radiation is detectable by the sensing element 706 when reflected back from objects (such as the user 100) in the scene 113.

The sensing element 706 comprises a 2D array of constituent 1D sensing elements so as to sense the non-visible radiation over two dimensions. Further, the projector 704 is configured to project the non-visible radiation in a predetermined radiation pattern. When reflected back from a 3D object such as the user 100, the distortion of this pattern allows the sensing element 706 to be used to sense the user 100 not only over the two dimensions in the plane of the sensor's array, but to also be used to sense a depth of various points on the user's body relative to the sensing element 706.

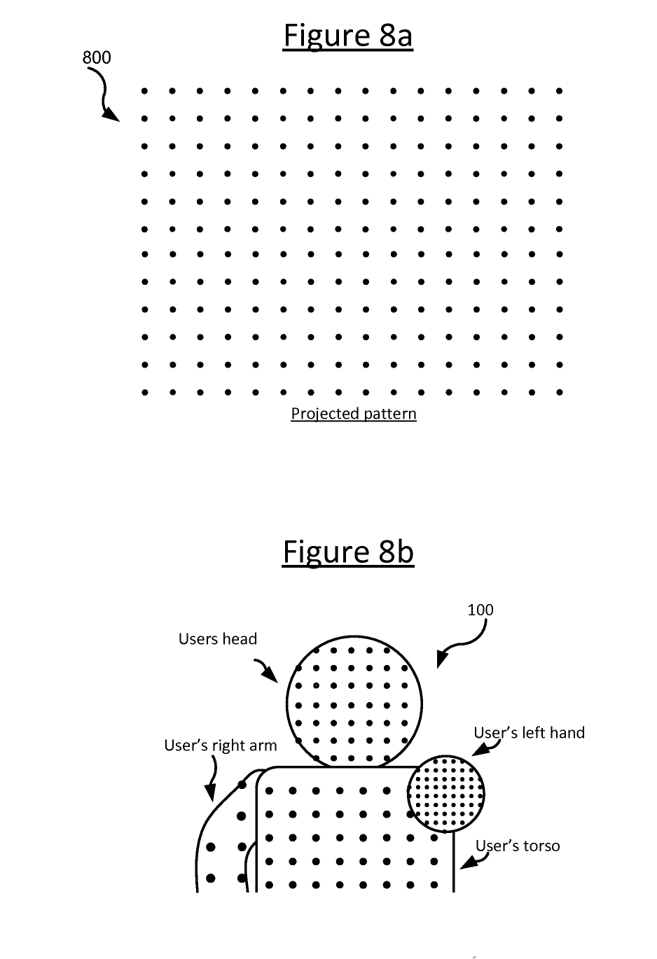

FIG. 8a shows an example radiation pattern 800 emitted by the projector 706. As shown in FIG. 8a, the radiation pattern extends in at least two dimensions and is systematically inhomogeneous, comprising a plurality of systematically disposed regions of alternating intensity. By way of example, the radiation pattern of FIG. 8a comprises a substantially uniform array of radiation dots. The radiation pattern is an infra-red (IR) radiation pattern in this embodiment, and is detectable by the sensing element 706. Note that the radiation pattern of FIG. 8a is exemplary and use of other alternative radiation patterns is also envisaged.

This radiation pattern 800 is projected forward of the sensor 706 by the projector 704. The sensor 706 captures images of the non-visible radiation pattern as projected in its field of view. These images are processed by the skeletal tracking algorithm 106 in order to calculate depths of the users' bodies in the field of view of the sensor 706, effectively building a three-dimensional representation of the user 100, and in embodiments thereby also allowing the recognition of different users and different respective skeletal points of those users.

FIG. 8b shows a front view of the user 100 as seen by the camera 103 and the sensing element 706 of the skeletal tracking sensor 105. As shown, the user 100 is posing with his or her left hand extended towards the skeletal tracking sensor 105. The user's head protrudes forward beyond his or her torso, and the torso is forward of the right arm. The radiation pattern 800 is projected onto the user by the projector 704. Of course, the user may pose in other ways.

As illustrated in FIG. 8b, the user 100 is thus posing with a form that acts to distort the projected radiation pattern 800 as detected by the sensing element 706 of the skeletal tracking sensor 105 with parts of the radiation pattern 800 projected onto parts of the user 100 further away from the projector 704 being effectively stretched (i.e. in this case, such that dots of the radiation pattern are more separated) relative to parts of the radiation projected onto parts of the user closer to the projector 704 (i.e. in this case, such that dots of the radiation pattern 800 are less separated), with the amount of stretch scaling with separation from the projector 704, and with parts of the radiation pattern 800 projected onto objects significantly backward of the user being effectively invisible to the sensing element 706. Because the radiation pattern 800 is systematically inhomogeneous, the distortions thereof by the user's form can be used to discern that form to identify skeletal features of the user 100, by the skeletal tracking algorithm 106 processing images of the distorted radiation pattern as captured by sensing element 706 of the skeletal tracking sensor 105. For instance, separation of an area of the user's body 100 from the sensing element 706 can be determined by measuring a separation of the dots of the detected radiation pattern 800 within that area of the user.

Note, whilst in FIGS. 8a and 8b the radiation pattern 800 is illustrated visibly, this is purely to aid in understanding and in fact in embodiments the radiation pattern 800 as projected onto the user 100 will not be visible to the human eye.

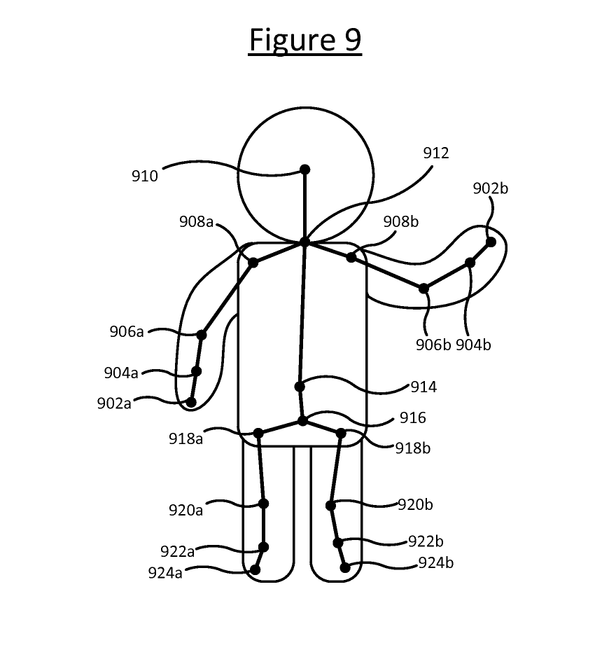

Referring to FIG. 9, the sensor data sensed from the sensing element 706 of the skeletal tracking sensor 105 is processed by the skeletal tracking algorithm 106 to detect one or more skeletal features of the user 100. The results are made available from the skeletal tracking algorithm 106 to the controller 112 of the encoder 104 by way of an application programming interface (API) for use by software developers.

The skeletal tracking algorithm 106 receives the sensor data from the sensing element 706 of the skeletal tracking sensor 105 and processes it to determine a number of users in the field of view of the skeletal tracking sensor 105 and to identify a respective set of skeletal points for each user using skeletal detection techniques which are known in the art. Each skeletal point represents an approximate location of the corresponding human joint relative to the video being separately captured by the camera 103.

In one example embodiment, the skeletal tracking algorithm 106 is able to detect up to twenty respective skeletal points for each user in the field of view of the skeletal tracking sensor 105 (depending on how much of the user's body appears in the field of view). Each skeletal point corresponds to one of twenty recognized human joints, with each varying in space and time as a user (or users) moves within the sensor's field of view. The location of these joints at any moment in time is calculated based on the user's three dimensional form as detected by the skeletal tracking sensor 105. These twenty skeletal points are illustrated in FIG. 9: left ankle 922b, right ankle 922a, left elbow 906b, right elbow 906a, left foot 924b, right foot 924a, left hand 902b, right hand 902a, head 910, centre between hips 916, left hip 918b, right hip 918a, left knee 920b, right knee 920a, centre between shoulders 912, left shoulder 908b, right shoulder 908a, mid spine 914, left wrist 904b, and right wrist 704a.

In some embodiments, a skeletal point may also have a tracking state: it can be explicitly tracked for a clearly visible joint, inferred when a joint is not clearly visible but skeletal tracking algorithm is inferring its location, and/or non-tracked. In further embodiments, detected skeletal points may be provided with a respective confidence value indicate a likelihood of the corresponding joint having been correctly detects. Points with confidence values below a certain threshold may be excluded from further use by the controller 112 to determine any ROIs.

The skeletal points and the video from camera 103 are correlated such that the location of a skeletal point as reported by the skeletal tracking algorithm 106 at a particular time corresponds to the location of the corresponding human joint within a frame (image) of the video at that time. The skeletal tracking algorithm 106 supplies these detected skeletal points as skeletal tracking information to the controller 112 for use thereby. For each frame of video data, the skeletal point data supplied by the skeletal tracking information comprises locations of skeletal points within that frame, e.g. expressed as Cartesian coordinates (x,y) of a coordinate system bounded with respect to a video frame size. The controller 112 receives the detected skeletal points for the user 100 and is configured to determine therefrom a plurality of visual bodily characteristics of that user, i.e. specific body parts or regions. Thus the body parts or bodily regions are detected by the controller 112 based on the skeletal tracking information, each being detected by way of extrapolation from one or more skeletal points provided by the skeletal tracking algorithm 106 and corresponding to a region within the corresponding video frame of video from camera 103 (that is, defined as a region within the afore-mentioned coordinate system).

It should be noted that these visual bodily characteristic are visual in the sense that they represent features of a user's body which can in reality be seen and discerned in the captured video; however, in embodiments, they are not “seen” in the video data captured by camera 103; rather the controller 112 extrapolates an (approximate) relative location, shape and size of these features within a frame of the video from the camera 103 based the arrangement of the skeletal points as provided by the skeletal tracking algorithm 106 and sensor 105 (and not based on e.g. image processing of that frame). For example, the controller 112 may do this by approximating each body part as a rectangle (or similar) having a location and size (and optionally orientation) calculated from detected arrangements of skeletal points germane to that body part.

The techniques disclosed herein uses capabilities of advanced active skeletal-tracking video capture devices such as those discussed above (as opposed to a regular video camera 103) to calculate one or more regions-of interest (ROIs). Note therefore that in embodiments, the skeletal tracking is distinct from normal face or image recognition algorithms in at least two ways: the skeletal tracking algorithm 106 works in 3D space, not 2D; and the skeletal tracking algorithm 106 works in infrared space, not in visible colour space (RGB, YUV, etc). As discussed, in embodiments, the advanced skeletal tracking device 105 (for example Kinect) uses an infrared sensor to generate a depth frame and a body frame together with the usual colour frame. This body frame may be used to compute the ROIs. The coordinates of the ROIs are mapped in the coordinate space of the colour frame from the camera 103 and are passed, together with the colour frame, to the encoder. The encoder then uses these coordinates in its algorithm for deciding the QP it uses in different regions of the frame, in order to accommodate the desired output bitrate.

The ROIs can be a collection of rectangles, or they can be areas around specific body parts, e.g. head, upper torso, etc. As discussed, the disclosed technique uses the video encoder (software or hardware) to generate different QPs in different areas of the input frame, with the encoded output frame being sharper inside the ROIs than outside. In embodiments, the controller 112 may be configured to assign a different priority to different ones of the ROIs, so that the status of being quantized with a lower QP than the background is dropped in reverse order of priority as increasing constraint is placed on the bitrate, e.g. as available bandwidth falls. Alternatively or additionally, there may be several different levels of ROIs, i.e. one region may be of more interest than the other. For example, if more persons are in the frame, they all are of more interest than the background, but the person that is currently speaking is of more interest than the other persons.

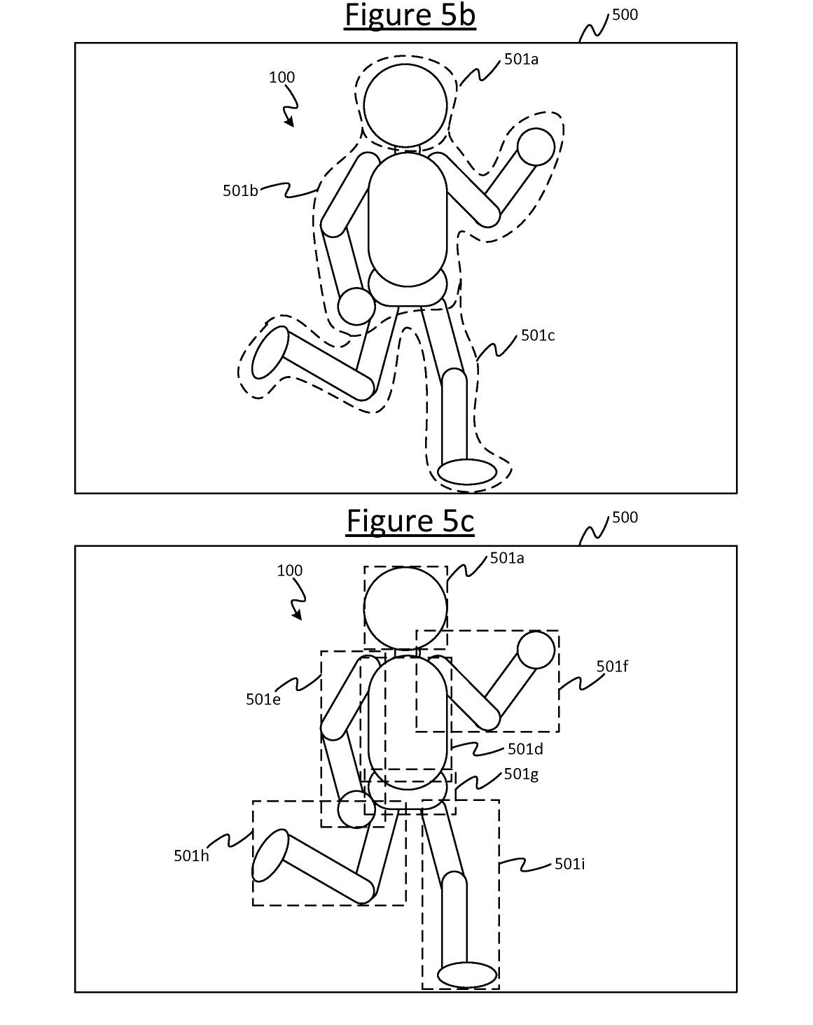

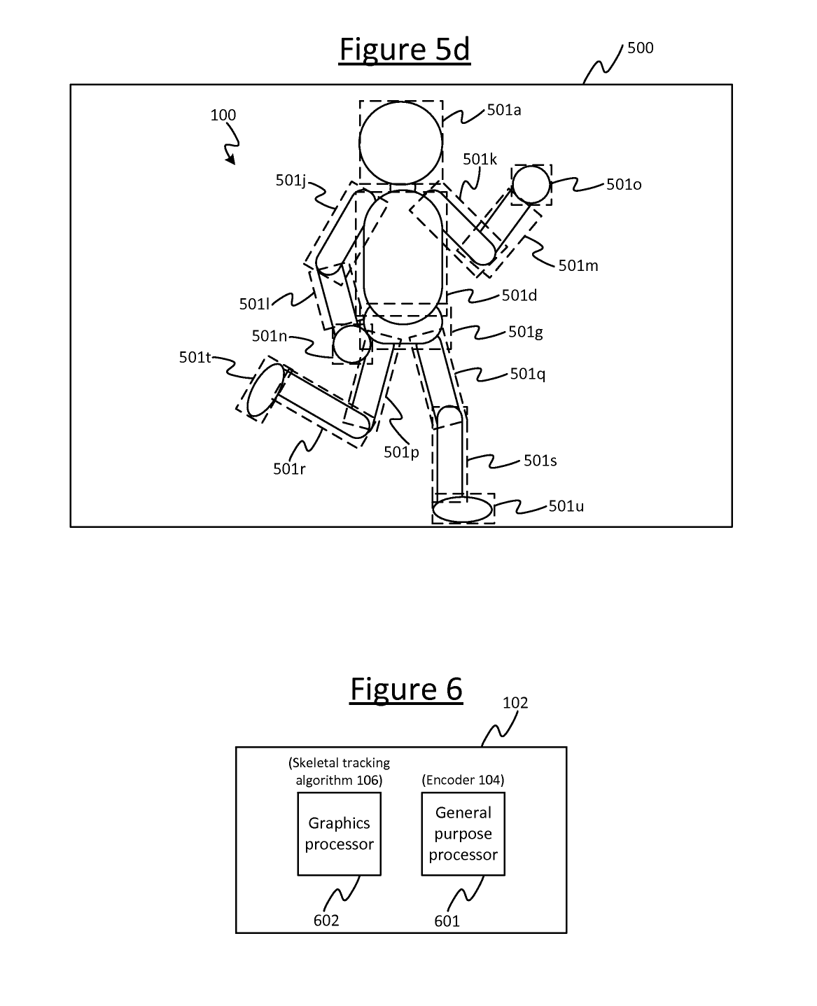

Some examples are discussed in relation to FIGS. 5a-5d. Each of these figures illustrates a frame 500 of the captured image of the scene 113, which includes an image of the user 100 (or at least part of the user 100). Within the frame area, the controller 112 defines one or more ROIs 501 based on the skeletal tracking information, each corresponding to a respective bodily area (i.e. covering or approximately covering the respective bodily area as appearing in the captured image).

FIG. 5a illustrates an example in which each of the ROIs is a rectangle defined only by horizontal and vertical bounds (having only horizontal and vertical edges). In the example given, there are three ROIs defined corresponding to three respective bodily areas: a first ROI 501a corresponding to the head of the user 100; a second ROI 501b corresponding to the head, torso and arms (including the hands) of the user 100; and a third ROI 501c corresponding to the whole body of the user 100. Note therefore that, as illustrated in the example, the ROIs and the bodily areas to which they correspond may overlap. Bodily areas as referred to herein do not have to correspond to single bones nor body parts that are exclusive of one another, but can more generally refer to any region of the body identified based on skeletal tracking information. Indeed, in embodiments the different bodily areas are hierarchical, narrowing down from the widest bodily area that may be of interest (e.g. whole body) to the most particular bodily area that may be of interest (e.g. head, which comprises the face)

FIG. 5b illustrates a similar example, but in which the ROIs are not constrained to being rectangles, and can be defined as any arbitrary shape (on a block-by-block basis, e.g. macroblock-by-macroblock).

In the example of each of FIGS. 5a and 5b, the first ROI 501a corresponding to the head is the highest priority ROI; the second ROI 501b corresponding to the head, torso and arms is the next highest priority ROI; and the third ROI 501c corresponding to the whole body is the lowest priority ROI. This may mean one or both of two things, as follows.

Firstly, as the bitrate constraint becomes more severe (e.g. the available network bandwidth on the channel decreases), the priority may define the order in which the ROIs are relegated from being quantized with a low QP (lower than the background). For example, under a severe bitrate constraint, only the head region 501a is given a low QP and the other ROIs 501b, 501c are quantized with the same high QP as the background (i.e. non ROI) regions; while under an intermediate bitrate constraint, the head, torso & arms region 501b (which encompasses the head region 501a) is given a low QP and the remaining whole-body ROI 501c is quantized with the same high QP as the background; and under the least severe bitrate constraint the whole body region 501c (which encompasses the head, torso and arms 501a, 501b) is given a low QP. In some embodiments, under the severest bitrate constraint, even the head region 501a may be quantized with the high, background QP. Note therefore that, as illustrated in this example, where it is said that a finer quantization is used in an ROI, this may mean only at times. Nonetheless, note also that the meaning of an ROI for the purpose of the present application is a region that (at least on some occasions) is given a lower QP (or more generally finer quantization) than the highest QP (or more generally coarsest quantization) region used in the image. A region defined only for purposes other than controlling quantization is not considered an ROI in the context of the present disclosure.

As a second application of the different priority ROIs such as 501a, 501b and 501c, each of the regions may be allocated a different QP, such that the different regions are quantized with different levels of granularity (each being finer than the coarsest level used outside the ROIs, but not all being the finest either). For example, the head region 501a may be quantized with a first, lowest QP; the body and arms region (the rest of 501b) may be quantized with a second, medium-low QP; and the rest of the body region (the rest of 501c) may be quantized with a third, somewhat low QP that is higher than the second QP but still lower than used outside. Note therefore that, as illustrated in this example, the ROIs may overlap. In that case, where the overlapping ROIs also have different quantization levels associated with them, a rule may define which QP takes precedent; e.g. in the example case here, the QP of the highest-priority region 501a (the lowest QP) is applied over all of highest-priority region 501a including where it overlaps, and the next highest QP is applied only over the rest of its subordinate region 501b, and so forth.

FIG. 5c shows another example where more ROIs are defined. Here, there is defined: a first ROI 501a corresponding to the head, a second ROI 501d corresponding to thorax, a third ROI 501e corresponding to the right arm (including hand), a fourth ROI 501f corresponding to the left arm (including hand), a fifth ROI 501g corresponding to the abdomen, a sixth ROI 501h corresponding to the right leg (including foot), and a seventh ROI 501i corresponding to the left leg (including foot). In the example depicted in FIG. 5c, each ROI 501 is a rectangle defined by horizontal and vertical bounds like in FIG. 5a, but alternatively the ROIs 501 could be defined more freely, e.g. like FIG. 5b.

Again, in embodiments, the different ROI 501a and 501d-I may be assigned certain priorities relative to one another, in a similar manner as discussed above (but applied to different bodily areas). For example, the head region 501a may be given the highest priority, the arm regions 501e-f the next highest priority, the thorax region 501d the next highest after that, then the legs and/or abdomen. In embodiments, this may define the order in which the low-QP status of the ROIs is dropped when the bitrate constraint becomes more constrictive, e.g. when available bandwidth decreases. Alternatively or additionally, this may mean there are different QP levels assigned to different ones of the ROIs depending on their relative perceptual significance.

FIG. 5d shows yet another example, in this case defining: a first ROI 501a corresponding to the head, a second ROI 501d corresponding to the thorax, a third ROI corresponding to the abdomen, a fourth ROI 501j corresponding to the right upper arm, a fifth ROI 501k corresponding to the left upper arm, a sixth ROI 501l corresponding to the right lower arm, a seventh ROI 501m corresponding to the left lower arm, an eighth ROI 501n corresponding to the right hand, a ninth ROI 5010 corresponding to the left hand, a tenth ROI 501p corresponding to the right upper leg, an eleventh ROI 501q corresponding to the left upper leg, a twelfth ROI 501r corresponding to the right lower leg, a thirteenth ROI 501s corresponding to the left lower leg, a fourteenth ROI 501t corresponding to the right foot, and a fifteenth ROI 501u corresponding to the left foot. In the example depicted in FIG. 5d, each ROI 501 is a rectangle defined by four bounds but not necessarily limited to horizontal and vertical bounds as in FIG. 5c. Alternatively each ROI 501 could be allowed to be defined as any quadrilateral defined by any four bounding edges connecting any four points, or any polygon defined by any three or more bounding edges connecting any three or more arbitrary points; or each ROI 501 could be constrained to a rectangle with horizontal and vertical bounding edges like in FIG. 5a; or conversely each ROI 501 could be freely definable like in FIG. 5b. Further, like the examples before it, in embodiments each of the ROIs 501a, 501d, 501g, 501j-u may be assigned a respective priority. E.g. the head region 501a may be the highest priority, the hand regions 501n, 5010 the next highest priority, the lower arm regions 5011, 501m the next highest priority after that, and so forth.

Note however that where multiple ROIs are used, assigning different priorities is not necessary implemented along with this in all possible embodiments. For example, if the codec in question does not support any freely definable ROI shape as in FIG. 5b, then the ROI definitions in FIGS. 5c and 5d would still represent a more bitrate efficient implementation than drawing a single ROI around the user 100 as in FIG. 5a. I.e. examples like FIGS. 5c and 5d allow a more selective coverage of the image of the user 100, that does not waste so many bits quantizing nearby background in cases where the ROI cannot be defined arbitrarily on a block-by-block basis (e.g. cannot be defined macroblock-by-macroblock).

In further embodiments, the quality may decrease in regions further away from the ROI. That is, the controller is configured to apply a successive increase in the coarseness of the quantization granularity from at least one of the one or more regions-of-interest toward the outside. This increase in coarseness (decrease in quality) may be gradual or step based. In one possible implementation of this, the codec is designed so that when an ROI is defined, it is implicitly understood by the quantizer 203 that the QP is to fade between the ROI and the background. Alternatively, a similar effect may be forced explicitly by the controller 112, by defining a series of intermediate priority ROIs between the highest priority ROI and the background, e.g. a set of concentric ROIs spanning outwards from a central, primary ROI covering a certain bodily area towards to the background at the edges of the image.

In yet further embodiments, the controller 112 is configured to apply a spring model to smooth a motion of the one or more regions-of-interest as they follow the one or more corresponding bodily areas based on the skeletal tracking information. That is, rather than simply determining an ROI for each frame individually, the motion of the ROI from one frame to the next is restricted based on an elastic spring model. In embodiments, the elastic spring model may be defined as follows:

$$m * \frac{{d}^{2} x}{d {t}^{2}} = - k * x - D * \frac{d x}{d t}$$

where m (“mass”), k (“stiffness”) and D (“damping”) are configurable constants, and x (displacement) and t (time) are variables. That is, a model whereby an acceleration of a transition is proportional to a weighted sum of a displacement and velocity of that transition.

For example, an ROI may be parameterized by one or more points within the frame, i.e. one or more points the position or bounds of the ROI. The position of such a point will move when the ROI moves as it follows the corresponding body part. Therefore the point in question can be described as having a second position (“desiredPosition”) at time t2 being a parameter of the ROI covering a body part in a later frame, and a first position (“currentPosition”) at time t1 being a parameter of the ROI covering the same body part in an earlier frame. A current ROI with smoothed motion may be generated by updating “currentPosition” as follows, with the updated “currentPosition” being a parameter of the current ROI:

velocity = 0
previousTime = 0
currentPosition = <some_constant_initial_value>
UpdatePosition (desiredPosition, time)
{
x = currentPosition − desiredPosition;
force = − stiffness * x − damping * m_velocity;
acceleration =force / mass;
dt = time − previousTime;
velocity += acceleration * dt;
currentPosition += velocity * dt;
previousTime = time;
}

It will be appreciated that the above embodiments have been described only by way of example.

For instance, the above has been described in terms of a certain encoder implementation comprising a transform 202, quantization 203, prediction coding 207, 201 and lossless encoding 204; but in alternative embodiments the teachings disclosed herein may also be applied to other encoders not necessarily including all of these stages. E.g. the technique of adapting QP may be applied to an encoder without transform, prediction and/or lossless compression, and perhaps only comprising a quantizer. Further, note that QP is not the only possible parameter for expressing quantization granularity.

Further, while the adaptation is dynamic, it is not necessarily the case in all possible embodiments that the video necessarily has to be encoded, transmitted and/or played out in real time (though that is certainly one application). E.g. alternatively, the user terminal 102 could record the video and also record the skeletal tracking in synchronization with the video, and then use that to perform the encoding at a later date, e.g. for storage on a memory device such as a peripheral memory key or dongle, or to attach to an email.

Further, it will be appreciated that the bodily areas and ROIs above are only examples, and ROIs corresponding to other bodily areas having different extents are possible, as are different shaped ROIs. Also, different definitions of certain bodily areas may be possible. For example, where reference is made to an ROI corresponding to an arm, in embodiments this may or may not include ancillary features such as the hand and/or shoulder. Similarly, where reference is made herein to an ROI corresponding to a leg, this may or may not include ancillary features such as the foot.

Furthermore, while advantages have been described above in terms of a more efficient use of bandwidth, or a more efficient use of processing resources, these are not limiting.

As another example application, the disclosed techniques can be used to apply a “portrait” effect to the image. Professional photo cameras have a “portrait mode”, whereby the lens is focused on the subject's face, whilst the background is blurred. This is called portrait photography, and it conventionally requires expensive camera lenses and professional photographers. Embodiments of the present disclosure can achieve the same or a similar effect with a video, in a video call, by using QP and ROI. Some embodiments even do more than the current portrait photography does: by increasing the blurring level gradually with distance outwards from the ROI, so the pixels furthest from the subject are blurred more than the ones closer to the subject.

Furthermore, note that in the description above the skeletal tracking algorithm 106 performs the skeletal tracking based on sensory input from one or more separate, dedicated skeletal tracking sensors 105, separate from the camera 103 (i.e. using the sensor data from the skeletal tracking sensor(s) 105 rather than the video data being encoded by the encoder 104 from the camera 103). Nonetheless, other embodiments are possible. For instance the skeletal tracking algorithm 106 may in fact be configured to operate based on the video data from the same camera 103 that is used to capture the video being encoded, but in this case the skeletal tracking algorithm 106 is still implemented using at least some dedicated or reserved graphics processing resources separate than the general-purpose processing resources on which the encoder 104 is implemented, e.g. the skeletal tracking algorithm 106 being implemented on a graphics processor 602 while the encoder 104 is implemented on a general purposes processor 601, or the skeletal tracking algorithm 106 being implemented in the systems space while the encoder 104 is implemented in the application space. Thus more generally than described in the description above, the skeletal tracking algorithm 106 may be arranged to use at least some separate hardware than the camera 103 and/or encoder 104—either a separate skeletal tracking sensor other than the camera 103 used to capture the video being encoded, and/or separate processing resources than the encoder 104.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device comprising:
an encoder for encoding a video signal representing a video image of a scene captured by a camera, the encoder comprising a quantizer for performing a quantization on said video signal as part of said encoding; and
a controller configured to receive skeletal tracking information from a skeletal tracking algorithm relating to one or more skeletal features of a user present in said scene, and based thereon to define one or more regions-of-interest within the video image corresponding to one or more bodily areas of the user, and to adapt the quantization to use a finer quantization granularity within the one or more regions-of-interest than outside the one or more regions-of interest.

2. The device of claim 1, wherein the controller is configured to define a plurality of different regions-of-interest each corresponding to a respective bodily area of the user, and to adapt the quantization to use a finer quantization granularity within each of said plurality of regions-of-interest than outside the plurality of regions-of-interest.

3. The device of claim 2, wherein one or more of the different regions-of-interest are quantized with the finer quantization granularity only at some times and not others.

4. The device of claim 3, wherein the controller is configured to adaptively select which of the different regions-of-interest is currently quantized with the finer quantization granularity in dependence on a current bitrate constraint.

5. The device of claim 4, wherein the bodily areas are assigned an order of priority, and the controller is configured to perform said selection according to the order of priority of the bodily areas to which the different regions-of-interest correspond.

6. The device of claim 2, wherein the controller is configured to adapt the quantization to use different levels of quantization granularity within different ones of said plurality of regions-of interest, each being finer than outside the plurality of regions-of-interest.

7. The device of claim 6, wherein said bodily areas are assigned an order of priority, and the controller is configured to set the different levels according to the order of priority of the bodily areas to which the different regions-of-interest correspond.

8. The device of claim 1, wherein each of the bodily areas is one of:
(a) the user's whole body;
(b) the user's head, torso and arms;
(c) the user's head, thorax and arms;
(d) the user's head and shoulders;
(e) the user's head;
(f) the user's torso
(g) the user's thorax;
(h) the user's abdomen;
(i) the user's arms and hands;
(j) the user's shoulders; or
(k) the user's hands.

9. The device of claim 5, wherein the order of priority is:
(i) the user's head;
(ii) the user's head and shoulders; or head, thorax and arms; or head, torso and arms;
(iii) the user's whole body;
such that (iii) is quantized with the finer quantization if the bitrate constraint allows, and if not only (ii) is quantized with the finer quantization if the bitrate constraint allows, and if not only (i) is quantized with the finer quantization.

10. The device of claim 7, wherein the order of priority is:
(i) the user's head;
(ii) the user's hands, arm, shoulders, thorax and/or torso;
(iii) the rest of the user's whole body;
such that is (i) quantized with a first level of quantization granularity, (ii) is quantized with one or more second levels of quantization granularity, and (iii) is quantized with a third level of quantization granularity, the first level being finer than each of the one or more second levels, each of the second levels being finer than the third level, and the third level being finer than outside the regions-of-interest.

11. The device of claim 1, comprising a transmitter configured to transmit the encoded video signal over a channel to at least one other device.

12. The device of claim 4, comprising a transmitter configured to transmit the encoded video signal over a channel to at least one other device, wherein the controller is configured to determine an available bandwidth of said channel, and said bitrate constraint is equal to or otherwise limited by the available bandwidth.

13. The device of claim 1, wherein the controller is configured to apply a successive increase in the coarseness of the quantization granularity from at least one of the one or more regions-of-interest toward the outside.

14. The device of claim 1, wherein the controller is configured to apply a spring model to smooth a motion of the one or more regions-of-interest as they follow the one or more corresponding bodily areas based on the skeletal tracking information.

15. The device of claim 1, comprising a transmitter for transmitting the encoded video signal over a network.

16. The device of claim 1, wherein the skeletal tracking algorithm is implemented on said device and is configured to determine said skeletal tracking information based on one or more separate sensors other than said camera.

17. The device of claim 1, comprising dedicated graphics processing resources and general purpose processing resources, wherein the skeletal tracking algorithm is implemented in the dedicated graphics processing resources and the encoder is implemented in the general purpose processing resources.

18. The device of claim 17, wherein the general purpose processing resources comprise a general purpose processor and the dedicated graphics processing resources comprise a separate graphics processor, the encoder being implemented in the form of code arranged to run on the general purpose processor and the skeletal tracking algorithm being implemented in the form of code arranged to run on the graphics processor.

19. A computer program product comprising code embodied on a computer-readable storage medium and configured so as when run on one or more processors to perform operations of:
encoding a video signal representing a video image of a scene captured by a camera, the encoding comprising performing a quantization on said video signal;
receiving skeletal tracking information from a skeletal tracking algorithm, relating to one or more skeletal features of a user present in said scene;
based on the skeletal tracking information, defining one or more regions-of-interest within the video image corresponding to one or more bodily areas of the user; and
adapting the quantization to use a finer quantization granularity within the one or more regions-of-interest than outside the one or more regions-of interest.

20. A method comprising:
encoding a video signal representing a video image of a scene captured by a camera, the encoding comprising performing a quantization on said video signal;
receiving skeletal tracking information from a skeletal tracking algorithm, relating to one or more skeletal features of a user present in said scene;
based on the skeletal tracking information, defining one or more regions-of-interest within the video image corresponding to one or more bodily areas of the user; and
adapting the quantization to use a finer quantization granularity within the one or more regions-of-interest than outside the one or more regions-of interest.
